(19) United States
(12) Patent Application Publication
(10) Pub. No.: US 2006/0101564 A1
(43) Pub. Date: May 18, 2006

(54) Portable multiple liner cuspidor

(76) Inventor: David K. Powdermaker, Flower Mound, TX (US)

Correspondence Address: STORM L.L.P., BANK OF AMERICA PLAZA, 901 MAIN STREET, SUITE 7100, DALLAS, TX, 75202, US

(21) Appl. No.: 10/988,099

(22) Filed: Nov. 12, 2004

(51) Int. Cl. A61J 19/00

(52) U.S. Cl. 4/259

(57) ABSTRACT

The present invention discloses a unique and novel portable cuspidor having a recepticle, with an upper chamber, adapted for holding a funnel and multiple stackable disposable liners, and a lower chamber for holding towelettes or for use as a storage compartment.

### RELATED ART

None.

### FIELD OF INVENTION

The present invention relates to cuspidors (spittoons), in particular to a new and improved portable multifunctional cuspidor with multiple disposable liners (sleeves). More specifically, the new cuspidor offers an alternative device for tobacco chewers, consisting of a cup with multiple disposable liners that eliminates the need to throw away cups or to clean cups; and a base designed to hold pre-moistened, disposable hand towelettes for cleaning afterwards.

### BACKGROUND OF THE INVENTION

The old ‘sit on the dash’ cuspidor was popular many years ago. With smokeless tobacco usage on the rise, snuff users are left helpless in any attempt to create a spit free environment. Numerous cuspidor devices have been developed for the use of tobacco chewers. These devices need to be washed, cleaned, or discarded after having been spit in repeatedly, as they tend to soil, smell or spill.

In the past, there have been attempts to have a cuspidor that requires no washing or cleaning. For instance, U.S. Pat. No. 6,305,033 to Azzam discloses a hand-held cuspidor which utilizes a standard throw-away foam polymer cup. This cuspidor device has a holder, a base adapted to receive a replaceable cup, and a cover that flips open exposing the cup. After several uses, the user opens the cuspidor and replaces the cup. The cuspidor is opened by unscrewing the base from the holder and replacing the cup. The principal disadvantage of this device is the difficulty in storing multiple disposable polymer cups. These cups do not stack well, preventing storage of multiple cups within the device, and taking up significant additional space in a vehicle. Also, these types of cups are brittle and can break easily. As a result, the user may just spit directly into the recepitcle, without insertion of the cup, as being more convenient, causing the recepticle to become smelly, unsightly, and unsanitary

U.S. Pat. No. 5,832,543 to Bosserman discloses a disposable portable pocket cuspidor, where a fill funnel is inserted through the open ended top and suspended within the container in order to direct spittle into the container. An absorbent material is retained within the container to absorb a tobacco chewer's spit. One major disadvantage with this device is the frequent need to clean the container as the spit, though absorbed by the absorbent material, may still come into contact with the walls of the container. Another disadvantage of this device is the requirement to use a special absorbent, without which, the device would be unsanitary.

Another attempt for a portable and disposable cuspidor is disclosed in U.S. Pat. No. 4,908,882 to Williams. The device thereby disclosed includes a funnel and a disposable liner having a disinfectant treated sponge. The sponge is secured adhesively on the interior floor of the disposable liner. When the sponge is saturated, the funnel is removed and the liner which is sealed by an attached wire twist tie is discarded. Then, the funnel and the interior of the receptacle may be washed. This device has the disadvantage of a cumbersome cup configuration, as it can not fit into standard cup holders; the type of plastic liner with absorbing and disinfectant material required; and the inconvenience of having to retrieve a liner from an external source for replacement in the device.

U.S. Pat. No. 4,159,549 to Layton discloses a cuspidor consisting of a hollow member having a lower closed end and an open upper end, with an open bag or liner that is inserted through the upper end. A disadvantage with this device is potential spilling of the contents and the inconvenience of having to dispose the bag almost immediately after use. Another disadvantage is the inconvenience of having to retrieve a liner from an external source for replacement in the device.

It is apparent that the prior art devices leave much to be desired in terms of convenience, and sanitation. All of the known prior art devices require separate storage of replacement liners. A portable cuspidor pleasing to use and easily maintained in a sanitary condition by means of conveniently stackable disposable liners is needed.

The various embodiments of the present invention individually and collectively provide numerous advantages over the prior art. A primary advantage of present invention is that it provides immediate and convenient access to disposable replacement liners. Another advantage of the present invention is that it provides a separate compartment for storage of personal items such as keys, or pocket change. Another advantage of another embodiment is that it provides a means for storage and dispensing of pre-moistened, disposable hand towelettes.

An additional advantage of this preferred embodiment is that it provides numerous features in a cuspidor body, which is similar to the size and shape of a common 12 oz. beverage container, and is thus compatible to fit within standard automobile cup holders. Other advantages of preferred embodiments of the present invention will become apparent from the following descriptions, taken in connection with the accompanying drawings, wherein, by way of illustration and example, an embodiment of the present invention is disclosed.

In a preferred embodiment of the present invention, a portable cuspidor is disclosed consisting of a cup retaining multiple disposable plastic liners. In another preferred embodiment, the cuspidor has a separate base compartment for convenient storage of personal items. In a more preferred embodiment, the cuspidor base is configured to store and dispense pre-moistened, disposable hand towelettes for cleaning afterwards.

### SUMMARY OF THE INVENTION

In a preferred embodiment of the present invention, a portable cuspidor is disclosed, having a substantially cylindrical body with an internal upper chamber and an internal lower chamber separated by a divider. The upper chamber is adapted to hold a plurality of disposable, stackable liners. In another preferred embodiment, an optional funnel extends downward into the uppermost disposable liner. In a more preferred embodiment of the invention, the funnel is oriented in an obliquely inclined plane to encourage spittle to travel downward easily, and to discourage spittle from spilling out of the cuspidor when the device is tilted.

In the preferred embodiment, stackable, disposable liners are insertable in the upper chamber. In a more preferred embodiment, the liners are suspended from a recessed shoulder on the top part of the upper chamber. The lower chamber forms a storage compartment for holding and disposing pre-moistened towelettes. It can alternatively be used to store personal items such as snuff, pocket change, or keys.

In another alternate embodiment, the cuspidor's outer surface can be decorated, embossed, engraved, imprinted, painted, or otherwise aesthetically distinguished. In another preferred embodiment, a cover is provided for supporting and protecting a printed graphic sheet.

### BRIEF DESCRIPTION OF THE DRAWINGS

The objects and features of the invention will become more readily understood from the following detailed description and appended claims when read in conjunction with the accompanying drawings in which like numerals represent like elements.

FIG. 1 is a front isometric view of the portable cuspidor according to a preferred embodiment of the present invention.

FIG. 2 is an exploded isometric view illustrating the components of the portable cuspidor according to a preferred embodiment of the present invention.

FIG. 3 is an isometric view of the lid of the base of the cuspidor.

FIG. 4 is a side sectional view illustrating the relationship of the components of the portable cuspidor, with an upper chamber having a funnel and stacked liners, and a lower chamber having a storage compartment, according to a preferred embodiment of the present invention.

FIG. 5 is a side sectional view of another preferred embodiment of the present invention illustrating the relationship of the components of the device. In this preferred embodiment, moist disposable towelettes are horizontally oriented in the lower chamber.

FIG. 6 is a side sectional view of another preferred embodiment of the present invention illustrating the relationship of the components of the device, which includes a handle.

### DETAILED DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the invention. Thus, the present invention is not intended to be limited to the embodiments shown, nor to a single collection of all the elements disclosed, but it is to be accorded the widest scope consistent with the principles and features disclosed herein.

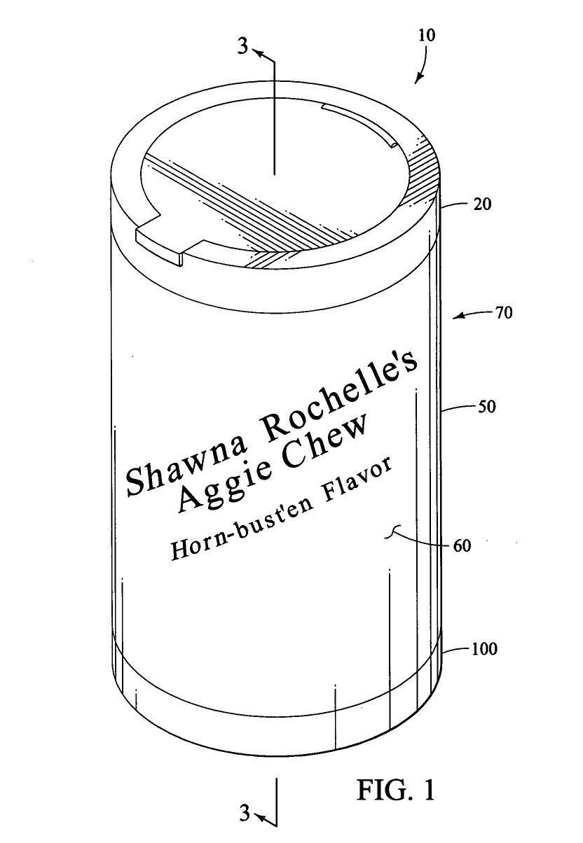

FIG. 1 is a front isometric view of a preferred embodiment of a portable cuspidor 10 of the present invention. It illustrates various components of a preferred embodiment of cuspidor 10. A body 70 is circumferentially surrounded by a cover cylinder 50, with a graphic sheet 60 wrapped around body 70 in a space formed between body 70 and cover cylinder 50. A cap 20 is removably attached to the top of body 70 and a base 100 is removably attached to the bottom of body 70.

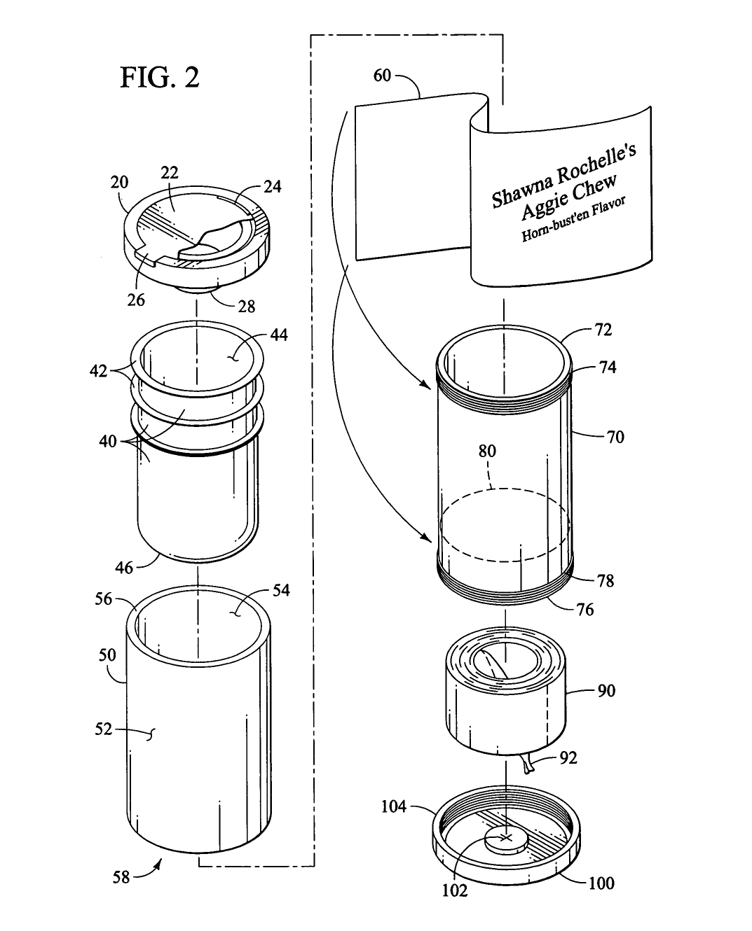

FIG. 2 is an exploded isometric view illustrating the components of preferred embodiment illustrated in FIG. 1. As seen in FIG. 2, cuspidor 10 has a cap 20. A lid 22 is pivotally attached to cap 20 by a hinge 24. A tab 26 is located on lid 22 opposite hinge 24. Tab 26 provides a means for pivoting lid 22 into an open position, away from cap 20. Stackable, disposable liners 40 are illustrated slightly separated. In a preferred embodiment, disposable liners 40 are made of a flexible plastic material. An example of the material type similar to that of the preferred embodiment is that used for collapsible liquid dispensers for infant bottles. In an alternate embodiment, disposable liners 40 are made of an absorbent material. Each of liners 40 has an upper lip portion 42 defining an open end 44. An opposite bottom end 46 is closed.

Still referring to FIG. 2, in a preferred embodiment, a cover cylinder 50 is provided. Cover cylinder 50 has an outer surface 52 and an interior surface 54. In another preferred embodiment, outer surface 52 has a rubberized texture. In another preferred embodiment, outer surface 52 is decorative, meaning it has been embossed, engraved, imprinted, painted or otherwise aesthetically distinguished. In another preferred embodiment, cover 50 is made of a transparent material.

An upper edge 56 is located between outer surface 52 and inner surface 54 at the top of cover 50. A lower edge 58 is located between outer surface 52 and inner surface 54 at the bottom of cover 50.

In another preferred embodiment, a graphic sheet 60 is provided. In the embodiment in which cover 50 is made of transparent material, sheet 60 is located against interior surface 54 of cover 50.

Still referring to FIG. 2, a body 70 is provided. In the preferred embodiment, body 70 is cylindrical. In a more preferred embodiment, the diameter of body 70 is between approximately 5 cm and approximately 9 cm. Body 70 has top end 72. An attachment means 74 in located proximate to top end 72. In a preferred embodiment, attachment means 74 is a threaded structure on the exterior surface of body 70.

Body 70 has bottom end 76. An attachment means 78 in located proximate to bottom end 76. In a preferred embodiment, attachment means 78 is a threaded structure on the exterior surface of body 70.

Still referring to FIG. 2, in a preferred embodiment, a disposable moist towelette roll 90 is provided. Such rolls are readily known in the art. They are perforated for separation during dispensing. They may contain cleaning ingredients, anti-bacterial ingredients and/or a fragrance.

A base 100 is provided for attachment to body 70. Base 100 has a flexible slotted opening 102 for dispensing individual towelettes 92 from towelette roll 90. Base 100 has an upwardly extending outer rim 104. In a more preferred embodiment, rim 104 is internally threaded for threaded connection to attachment means 78 of body 70.

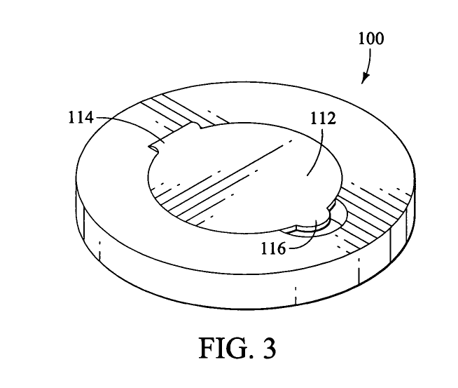

FIG. 3 is an isometric view of a preferred embodiment of base 100. In this view it is seen that a lid 112 is attached to base 100 by a hinge 114. A tab 116 is located on lid 112 opposite hinge 114. Tab 116 provides a means for pivoting lid 112 into an open position away from base 100.

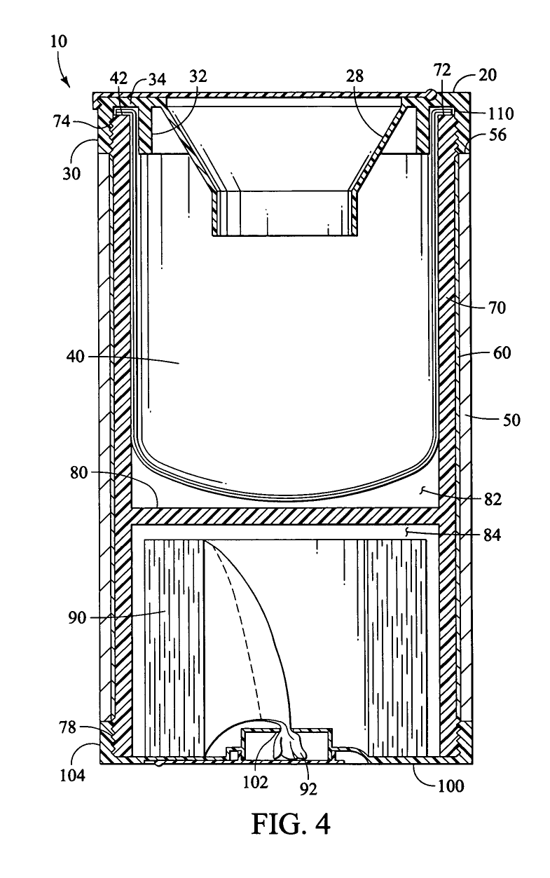

FIG. 4 is a side sectional view illustrating the components of various embodiments of cuspidor 10. In a preferred embodiment, a funnel 28 depends downward from the interior of cap 20. Cap 20 has a downwardly extending outer rim 30. In a more preferred embodiment, rim 30 is internally threaded. In another embodiment, cap 20 also has a downwardly extending spacer 32. Cap 20 is removable attached to body 70 by a threaded connection between outer rim 30 and attachment means 74. In the preferred embodiment, the connection of cap 20 to body 70 creates a circumferential space 110 between a ring portion 34 of cap 20 and top end 72 of body 70. Ring 34 is located internally between rim 30 and spacer 32. A plurality of stackable, disposable liners 40 is located inside upper chamber 82 of body 70. Lip portions 42 of disposable liners 40 are located inside circumferential space 110.

In the preferred embodiment illustrated in FIG. 4, it is seen that body 70 has a divider 80. Divider 80 divides the interior of body 70 into an upper chamber 82 and a lower chamber 84. Upper chamber 82 is designed to hold a plurality of disposable liners 40. Lower chamber 84 forms a storage space adapted with slotted opening 102 at the bottom of base 100 to facilitate removal of individual towelettes 92 therein. Base 100 is removably attached to body 70 by a threaded connection between an outer rim 104 and attachment means 78.

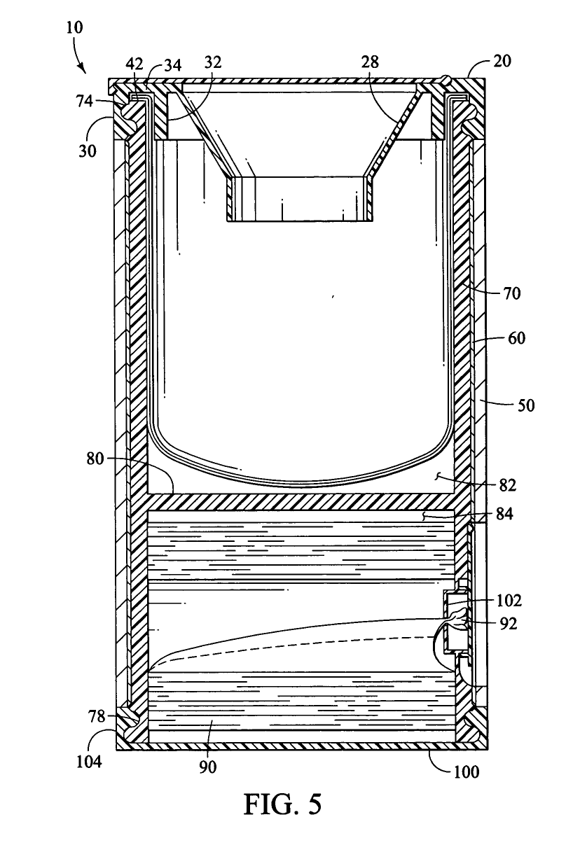

FIG. 5 is also a side sectional view illustrating the relationship of the components of various embodiments of cuspidor 10. In the preferred embodiment, illustrated in FIG. 5, lower chamber 84 forms a storage space adapted with slotted opening 102 on one side of base 100 to facilitate removal of individual towelettes 92 laterally. As shown in this view, cap 20 is removably attached to body 70 by a snap-on connection between outer rim 30 and attachment means 74. In this view, base 100 is also removably attached to body 70 by a snap-on connection between outer rim 104 and attachment means 78.

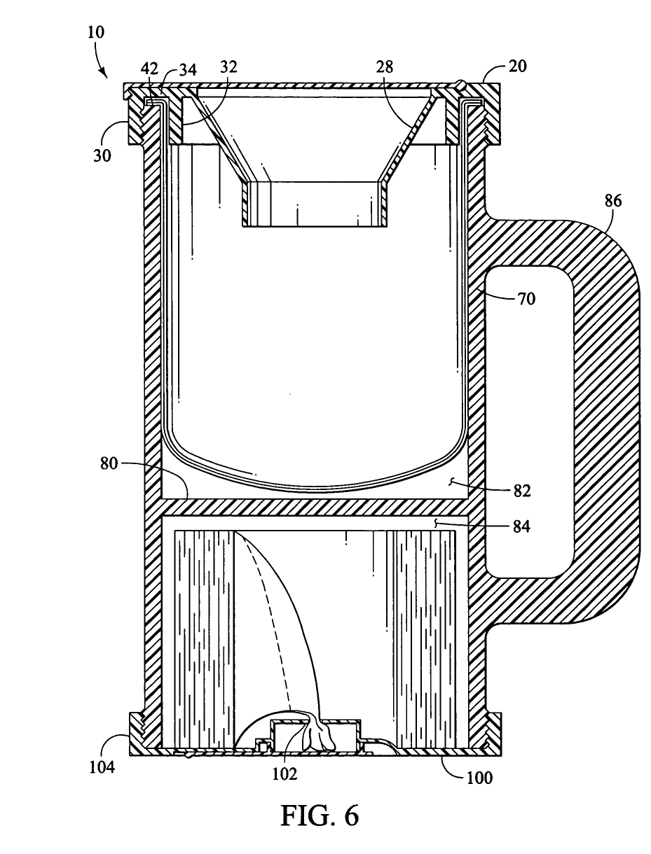

FIG. 6 is a side sectional view illustrating the relationship of the components of various embodiments of cuspidor 10, as described in FIGS. 4 and 5. In this preferred embodiment, a handle 86 is laterally attached to cover cylinder 50.

### OPERATION OF THE INVENTION

Referring to FIG. 4, the assembly of a preferred embodiment of cuspidor 10 is illustrated. As seen in FIG. 4, cap 20 is removably attached to body 70. In the embodiment illustrated, this is achieved by a threaded connection of outer rim 30 of cap 20 to attachment means 74 of body 70. In an alternate embodiment (illustrated in FIG. 5), a snap-on connection between outer rim 30 and attachment means 74 is provided.

In the preferred embodiment, the connection of cap 20 to body 70 creates a circumferential space 110 between ring 34 of cap 20 and top end 72 of body 70. A plurality of stackable, disposable liners 40 is located inside upper chamber 82 of body 70. The lip portions 42 of disposable liners 40 are located inside circumferential space 110.

In the preferred embodiment, upper edge 56 of cover cylinder 50 engages outer rim 30 of cap 20 when cap 20 is attached to body 70. In this manner, the engagement can establish the height of circumferential space 110 within which the lip portions 42 of liners 40 are located. Also in a preferred embodiment, a funnel 28 extends downward from cap 20 into upper chamber 82. This configuration directs discharged spit into open end 44 of liner 40, illustrated in FIG. 2.

As shown in FIGS. 1 and 2, graphic sheet 60 may be imprinted with a commercial message or identifier advantageous to the marketing of the device. Graphic sheet 60 is flexible and may by wrapped around body 70. In the preferred embodiment, cover cylinder 50 has an inside diameter greater than the outside diameter of body 70. Cover cylinder 50 is located over body 70 and graphic sheet 60. In the preferred embodiment, cover cylinder 50 is made of a transparent material, allowing for protected view of graphic sheet 60. In this manner, cuspidor 10 can be utilized as a marketing tool, and/or provided with selectable decorative L graphics.

In an alternative embodiment, not shown, outer surface 52 is a rubberized or textured surface that provides an enhanced gripping surface. In another preferred embodiment, outer surface 52 is decorative, meaning it has been embossed, engraved, imprinted, painted or otherwise aesthetically distinguished, thus eliminating the need for a graphic sheet 60. In another preferred embodiment, illustrated in FIG. 6, a handle 86 is laterally attached to cover cylinder 50.

Referring to FIG. 4, base 100 is attached to body 70 to enclose lower chamber 84. In the embodiment illustrated, this is achieved by threaded connection of outer rim 104 of base 100 to attachment means 78 of body 70. In an alternate embodiment, shown in FIG. 5, a snap-on connection between outer rim 104 and attachment means 78 is provided.

Lower chamber 84 provides an accessible storage space for the user of cuspidor 10. While the use of the space is left to the discretion of the user, it is foreseeable that the user may elect to store money, chewing tobacco, keys, extra liners 40 or other items of convenience in the space. In the preferred embodiment, towelette roll 90 comprising a series of attached pre-moistened disposable towelettes 92 is located in lower chamber 84. In this embodiment base 100 has a slotted opening 102 through which individual towelettes 92 are removed in sequence from roll 90. This is a familiar configuration in household cleaning products, in which the towelettes are large and occupy a unitary chamber.

In a preferred embodiment, illustrated in FIG. 3, base 100 has a lid 112 attached to base 100 by a hinge 114. A tab 116 is located on lid 112 opposite hinge 114. Tab 116 provides a means for pivoting lid 112 into an open position, away from base 100.

Towelette roll 90 used in the present invention may be substantially smaller in size than commercially available household cleaning brands, based on the application and lower chamber 84 size limitations. This can be accomplished, in part, by providing a towelette 92 that is rectangular shaped. As the perforated end of each adjoining towelette 92 reaches slotted opening 102, it is separated from roll 90, and thus available for individual use. Due to the messy nature of tobacco products, there is a great utility in convenient access to towelettes 92.

In use, lid 22 is pivoted opened and away from cap 20 about hinge 24. Used tobacco may then be discharged into funnel 28, which extends into upper chamber 82, beneath, and interior of open end 44 of disposable liner 40, illustrated in FIG. 2. As a result, spittle accumulates in disposable liner 40. Lid 22 may be closed to prevent spittle from escaping from liner 40. Additionally, funnel 28 encourages delivery and retention of spittle within liner 40.

As liner 40 becomes full, cap 20 is removed from body 70, permitting access to liner 40 for removal and disposal. Beneficially, when liner 40 is removed, a clean liner 40 is exposed in position for immediate use. Cap 20 is reattached to body 70 and cuspidor 10 is ready for use.

When needed, the user may open base lid 112, and pivot it away from base 100 about base hinge 114. This provides access to towelettes 92 of towelette roll 90 through slotted opening 102. As a single towelette 92 is removed, it is separated from roll 90 when the force created by slotted opening 102 on towelette 92 exceeds the tensile strength of the perforated connections between sequentially attached towelettes 92 of roll 90. Base lid 112 acts to retain or exclude moisture within lower chamber 84 that might otherwise escape through slotted opening 102 and the partially exposed towelette 92 left protruding therein.

It is apparent that various modifications may be made to the above described preferred embodiments of the invention without departing from the spirit and scope of the invention.

I claim:

1. A portable cuspidor, comprising:
a body;
an upper chamber;
a lower chamber;
a divider separating the upper chamber and the lower chamber;
a cap removably attached to the top of the body; and
a base removably attached to the bottom of the body.

2. The portable cuspidor of claim 1, wherein a lid is attached to the cap by a hinge.

3. The portable cuspidor of claim 1, wherein a funnel depends downward from the inside of the cap.

4. The portable cuspidor of claim 1, wherein the upper chamber is adapted to hold multiple liners.

5. The portable cuspidor of claim 1, wherein the lower chamber is a storage compartment.

6. The portable cuspidor of claim 1, wherein a lower lid is hingedly attached to the base.

7. The portable cuspidor of claim 1, wherein the base has a cover with an inner surface and an outer surface

8. The portable cuspidor of claim 7, wherein the cover is generally cylindrical.

9. The portable cuspidor of claim 7, wherein the cover is made of transparent material.

10. The portable cuspidor of claim 7, wherein a graphic sheet can be inserted between the cover and the body of the cuspidor.

11. The portable cuspidor of claim 7, wherein the outer surface of the cover has a rubberized texture.

12. The portable cuspidor of claim 7, wherein the outer surface of the cover is embossed.

13. The portable cuspidor of claim 7, wherein the outer surface of the cover is engraved.

14. The portable cuspidor of claim 7, wherein the outer surface of the cover is imprinted.

15. The portable cuspidor of claim 1, wherein the base has a slotted opening to facilitate dispensing of perforated disposable towelettes.

16. A portable cuspidor comprising:
a body having an interior chamber;
the interior chamber capable of receiving multiple liners; and
a cap removably attached to the top of the body.

17. The portable cuspidor of claim 16, further comprising:
a divider forming the base of the interior chamber;
a lower chamber located below the divider; and
a base removably attached to the bottom of the body.

18. The portable cuspidor of claim 17, further comprising a towelette dispenser in the lower chamber.
